(19) United States
(12) Patent Application Publication
(10) Pub. No.: US 2012/0251286 A1
(43) Pub. Date: Oct. 4, 2012

(54) Device for emergency lightering of a container ship and use of said device

(75) Inventors: Dirk Robert VAN DER VELDEN, RHOON (NL); Theodorus Menno HAAK, MAASSLUIS (NL); Geert Jan Jacob VERVER, DELFT (NL)

(73) Assignee: SMIT NEDERLAND B.V., ROTTERDAM (NL)

(21) Appl. No.: 13/434,901

(22) Filed: Mar. 30, 2012

(30) Foreign Application Priority Data
Mar. 30, 2011 (EP) 11160333.8

(51) Int. Cl. B66C 1/42

(52) U.S. Cl. 414/732; 414/815

(57) ABSTRACT

A mobile container manipulator device (3) includes ISO container engagement parts (5, 6) interconnected by a manipulator body (4), each of which container engagement parts (5, 6) is to be coupled to a respective ISO container (2). The manipulator body (4) has an adjustable length and has length adjustment element (12) providing a variable distance between the container engagement parts (5, 6). The respective connections between the manipulator body (4) and each container engagement part (5, 6) each have at least one pivot joint (13, 16, 21) and have angle adjustment elements (15, 18) providing a variable angular orientation of the container engagement part (5, 6) with respect to the manipulator body (4). The container manipulator device (3) is used for lightering a grounded container ship.

### FIELD OF THE INVENTION

The invention is related to the field of handling large ISO containers (for instance 10′, 20′, 40′, 45′ containers) which are used for transporting goods. Such containers are stacked upon each other in the hold and on the deck of a container ship. Normally, the containers are transferred between the ship and a quay by means of dedicated shoreside cranes. The transport of goods by means of such containers has shown a rapid growth, which means that an ever increasing number of ships is travelling back and forth between a large number of ports. Also the size of container ships has shown a rapid increase.

Although the transport of goods by means of containers has had a positive influence on trade economics, nevertheless there are risks involved as well. The increasing number of containers transported over the seas makes it more likely that at some point in time a container ship will sustain damage or will be grounded or will even sink. In particular the risk of grounding seems inevitable, having regard to the shallow waters which prevail in the vicinity of most large ports. However, the process of subsequently refloating a loaded container ship is expected to lead to numerous problems, in particular in the case of large sized container ships, such as ULCS's (ultra large container ship) which for instance may contain thousands of containers. As an example, such ships may carry 8.000 or 10.000 or more TEU's (twenty foot equivalent unit).

### BACKGROUND OF THE INVENTION

For the purpose of refloating the ship it may be necessary to lighter the ship so as to reduce its draft. In the case of a container ship, this would mean the unloading of containers from the ship's deck; however this is a very cumbersome process or in fact even impossible due to the absence of container handling equipment under these circumstances. For smaller container ships, it is an option to remove containers from the ship's deck by means of a barge mounted crane which is positioned alongside the container ship. However, the width of ULCS's has meanwhile become so large that containers which are somewhere in the middle of the deck, are completely out of reach of barge mounted cranes.

A grounded container ship may however severely threaten the accessibility of the nearby port, in such a way that the transport of goods might even come to a complete stand still. Also, the risk which a grounded ship poses to the environment, further increases the pressure to provide quick relief. The nature of the goods, e.g. in the case of dangerous or perishable goods, which are transported in the containers make it even more compelling to provide a solution to this problem.

### SUMMARY OF THE INVENTION

The object of the invention is therefore to provide the possibility to handle the containers on a stricken container ship, in particular in case such ship is grounded. A further object is to provide an option whereby the containers can still be salvaged without being flooded. In that case, the goods transported in the containers are still valuable and worthwhile to be recuperated.

Said object is first of all achieved by means of a mobile container manipulator device, comprising two container engagement parts interconnected by a manipulator construction or body, each of which container engagement parts is to be coupled to a respective container, said manipulator body having an adjustable length and having length adjustment means providing a variable distance between said container engagement parts, the respective connections between the manipulator body and each container engagement part each having at least one pivot joint and having angle adjustment means providing a variable angular orientation of the container engagement part with respect to the manipulator body. Furthermore, a strengthening arrangement may be provided for the container onto which the manipulator is mounted.

In particular for the purpose of handling a ship in distress, it is advantageous to apply a container manipulating device which is equipped with its own power source. Such device is independent of any external power source, although it is possible to supply full or additional external power, e.g. from a tug boat and the like.

The engagement parts of the container manipulating device can be carried out in any way as desired for cooperation with the containers and for connection thereto. Thus, preferably each container engagement part may comprise a respective spreader provided with twistlock devices. However, any other equipment which is fit for connection to a container is suitable as well, such as a chain or wire connection and the like.

As mentioned before, the manipulator body is carried out in such a way that the engagement parts are moveable with respect to each other according to several modes which encompass rectilinear movements and rotational movements. Thus, the manipulator body may comprise a central beam, such as a telescopic beam, as well as arms which are rotatably suspended at both ends of the central beam. Preferably, said arms are articulated. Also, the arms may be rotatable by means of piston/cylinder devices. The central beam may have an adjustable length. The drive means may be hydraulically or electrically operated.

The invention is also related to a use of a mobile container manipulator device as described before having two container engagement parts which are interconnected by a manipulator body provided with self-contained drive apparatus by means of which the distance and/or the angular orientation of said container engagement parts is influenced, said use comprising the steps of:
providing a containers which are arranged according to adjacent stacks of containers, wherein containers of a stack are locked with respect to other containers in the stack,
making the container engagement parts of the mobile container manipulator device engage different containers,
unlocking one of said containers onto which the mobile container manipulator device is engaged from a container in the same stack,
moving said unlocked container by energizing the drive apparatus of the manipulator body while changing the distance and/or angular orientation of said unlocked container with respect to the other container onto which the container manipulation device is engaged.

By means of the container manipulating device, which can for instance be brought on board the stricken ship through a tug boat or otherwise through a barge or helicopter, the containers loaded onboard the ship can be handled and moved as desired. For instance, the containers can be taken from the center to the side, such that subsequently they can be handled further in the traditional way by a barge mounted crane alongside the container ship. Thus, the containers are transferred to a container barge for further transport onshore.

As mentioned, containers in a stack are locked with respect to each other for stabilization purposes. The method may therefore additionally comprise the steps of unlocking one of said containers onto which the mobile container manipulator device is engaged from a container in the same stack, while maintaining the connection of the other container onto which the mobile container manipulator device is engaged to a container in the other stack. The process of unlocking the containers may for instance be carried out by hand. However, in case the stacks are subjected to side loads due to a tilted position of the grounded container ship, it may be necessary to unlock the containers by means of cutting torches.

In general, the container manipulating device supports itself on the stacks of containers for handling a specific container. The container to be handled may be a container which is at a higher position in the stack onto which the device has anchored itself by means of one of its engagement parts. However, preferably the container engagement parts engage containers in different stacks. Thus, the engagement part is able to handle and move a container which is lifted from a stack other than the stack onto which the mobile container manipulator device is engaged in a stationary fashion. Said container which represents the fixed point for the container manipulating device is preferably locked in position with respect to the other containers in its stack.

The container manipulating device can be applied in a very versatile way, according to which it can propel itself by walking or climbing over the several adjoining stacks so as to reach a specific desired location. This may especially be the case for reaching containers in the central area of the deck load. The container manipulating device then passes from one container to another and so forth, without unlocking said containers which are grasped by the container manipulating device. In this connection, it is possible to make the mobile container manipulator device engage containers which are positioned at different levels, such as a difference in level which is equal to the height of a single container or of multiple containers. Also, the container engagement parts can be connected to the top or to a side wall of the containers.

The invention is thus related to a further use of a mobile container manipulator device as described before having container engagement parts which are interconnected by a manipulator body provided with drive apparatus by means of which the distance and/or the angular orientation of said container engagement parts is influenced, comprising the steps of:
providing containers which are arranged according to adjacent stacks of containers
making one of the container engagement parts of the mobile container manipulator device engage a first container and the other of the container engagement parts a second container,
releasing a container engagement part from the respective container while maintaining the engagement between the other container engagement part and the respective container,
influencing the distance and/or the angular orientation of the released container engagement part with respect to the engaged container engagement part,
engaging said released container engagement part with a third container.

Thus, the container manipulating device can propel itself over a number of stacks, until it reaches the location where containers are to be removed and which are to be displaced towards the side edges of a container deck load which consists of multiple stacks next to each other.

It is to be noted that in the above uses, the container manipulator device is void of any connection to a crane or to hoisting cables of a crane. Although the container manipulator device may comprise handling means, such as a lifting eye, for positioning the device at a desired location e.g. by means of a barge mounted crane, the actual operation of the device does not depend on any cooperation with lifting equipment and the like. Thus, in this sense the container manipulating device is a truly self-supporting and independent tool. It is to be understood that the operation of the device may depend on remote control, e.g. by means of signal cables or radio signals and the like.

### DESCRIPTION OF DRAWINGS

The invention will now be described with reference to the example shown in the drawings.

FIG. 1 shows the container manipulating device attached to two locked containers.

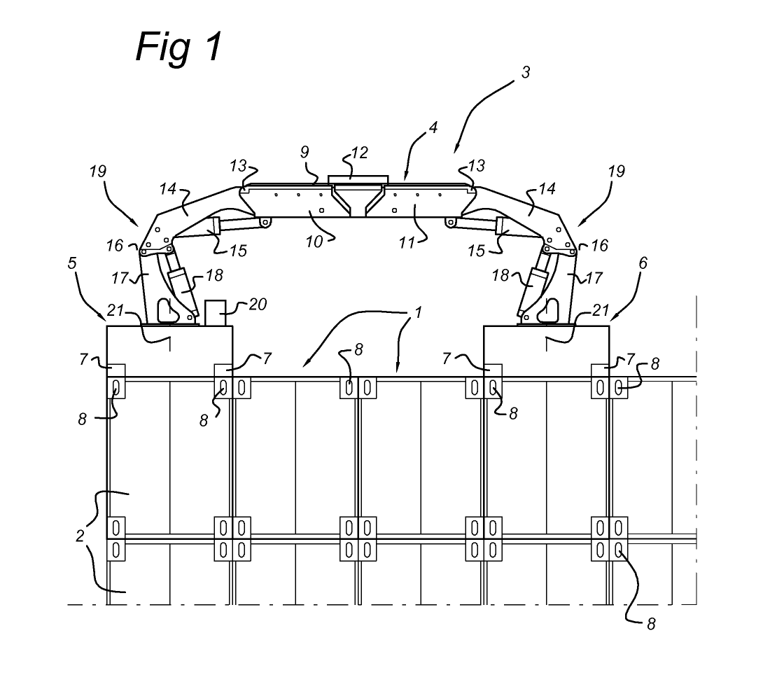

FIG. 2 shows the container manipulating device attached to a locked container while lifting away another container.

### DESCRIPTION OF PREFERRED EMBODIMENT

The figures show several stacks 1 of containers 2 which, in each stack, are locked with respect to each other for purposes of stability. In normal practice, such stacks of containers are loaded in or unloaded from container ships by means of shoreside container cranes positioned in a port. However, in case the container ship becomes grounded at sea or open waters, no shoreside container cranes are available for recovering the containers or removing the containers from the ship for lightering said ship.

For the purpose of providing a solution to the problems of lightering a ULCC, or for unloading of containers from the container ship in the absence of container cranes, the mobile container handling device 3 is provided. Said mobile container handling device 3 consists of the manipulator construction or body 4 which at its opposite ends carries the container engagement parts, such as spreaders, 5, 6. These container engagement parts 5, 6 are each provided with so-called twistlocks 7 at their corners, which are able to connect the container engagement parts 5, 6 to the corner castings 8 which are present on all corners of the containers 2.

The manipulator body 4 has a beam 9 which consists of adjustable beam parts 10, 11, the position of each with respect to each other can be adjusted by a hydraulic piston/cylinder device 12. At the opposite ends, the adjustable beam parts 10, 11 are each connected, through a transverse hinge 13, to an articulated arm 19, which consists of articulated arm parts 14, 17. The articulated arm parts 14, 17 themselves are interconnected through a transverse hinge 16. By means of the hydraulic piston/cylinder devices 15, 18, the articulated arms 19 may be rotated as desired with respect to the beam 9. Although not shown, it is possible to make the articulated arms 19 also rotatable with respect to the beam 9 according to a longitudinal hinge 22 which is coincident with the longitudinal direction of said beam 9.

Furthermore, one or both of the container engagement parts 5 is equipped with a power source 20 for driving a hydraulic pump for energizing the piston/cylinder devices mentioned before. Also, a fuel tank is present containing an amount of fuel for operating the combustion engine of the power source.

In practice, one of the container engagement parts 5 is connected to an upper container of a stack 1 by means of the twistlocks 7 and the corner castings 8 of said container. As said container is locked with respect to the lower containers, said container forms a firm and reliable basis for the mobile container manipulating device 3. Subsequently, the other container manipulating part 6 is connected to another container, also by means of its twistlocks 7 and the upper corner castings 8 of said other container. Said other container is unlocked from the lower containers in the stack.

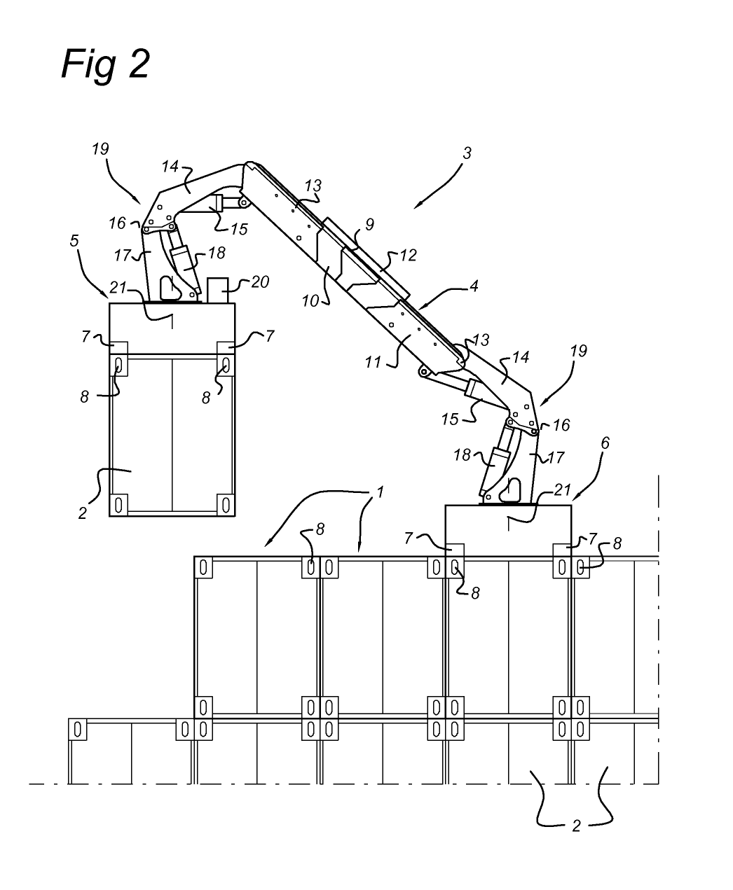

By now manipulating the hydraulic pistons/cylinder devices 12, 15 and 18 as addressed before, it is possible to lift said other container from its stack while the first container which is still locked to its lower container forms a firm basis for this heaving action. Subsequently, the lifted container may be deposited at another desired spot, for instance near the edge of the deck of the container vessel for unloading onto a lighter barge with a mobile crane. In this connection, it may be desirable to make the articulated arm parts 17 rotatable about a slewing hinge 21 which is transverse with respect to the axes of the transverse hinges 13, 16 of the arm parts 14, 17 as schematically shown in FIG. 2. A suitable drive device (not shown) for carrying out said rotations is present as well

Although the container and manipulating device 3 according to the invention has been shown engaging the containers in question on their upper side, it is also possible to engage the containers at one of their vertical sides in case these are accessible. Also in that case, the container engagement parts 5, 6 may be connected to the corner castings 8 by means of the twistlocks 7.

### LIST OF REFERENCES

1. Stack of containers
2. Container
3. Container manipulating device
4. Manipulator body
5. Container engagement part
6. Container engagement part
7. Twistlock
8. Corner casting
9. Beam
10. Beam part
11. Beam part
12. Hydraulic piston/cylinder device
13. Transverse hinge of arm
14. Articulated beam part
15. Hydraulic piston/cylinder device
16. Transverse hinge of arm
17. Articulated beam part
18. Hydraulic piston/cylinder device
19. Articulated arm
20. Powerpack
21. Slewing hinge
22. Longitudinal hinge of arm

1. Mobile container manipulator device (3), comprising ISO container engagement parts (5, 6), such as spreaders provided with twist lock devices (7), interconnected by a manipulator body (4), each of which container engagement parts (5, 6) is to be coupled to a respective ISO container (2), said manipulator body (4) having an adjustable length and having length adjustment means (12) providing a variable distance between said container engagement parts (5, 6), the respective connections between the manipulator body (4) and each container engagement part (5, 6) each having at least one pivot joint (13, 16, 21, 22) and having angle adjustment means (15, 18) providing a variable angular orientation of the container engagement part (5, 6) with respect to the manipulator body (4).

2. Manipulator device (3) according to claim 1, wherein the manipulator body (4) and the capacity of the drive means (12, 15, 18) are carried out for transferring a force and/or a bending moment and/or a torsion moment between the container engagement parts (5, 6) which are generated by the load of an ISO container (2) loaded to its maximum mass capacity exerted on one of the container engagement parts (5, 6) while the other container engagement part (5, 6) is held stationary.

3. Manipulator device (3) according to claim 1, wherein a power source (20) is provided, such as a combustion engine or electric battery, for powering the drive means, said power source being supported on the manipulator body (4) and/or at least one of the container engagement parts (5, 6).

4. Manipulator device (3) according to claim 1, wherein the manipulator body (4) comprises a central beam (9), such as a telescopic beam (10, 11), as well as arms (19) which are rotatably suspended at both ends of the central beam (9), e.g. through a transverse hinge axis (13, 16) oriented transverse with respect to the longitudinal direction of the central beam (9) and/or a longitudinal hinge axis (22) oriented according to the longitudinal direction of the central beam (9).

5. Manipulator device (3) according to claim 4, wherein the arms (19) are articulated (14, 17) according to at least two arm parts (14, 17).

6. Manipulator device (3) according to claim 4, wherein the arm parts (14, 17) of an arm (19) are rotatable, e.g. by means of piston/cylinder devices (15, 18), according to parallel hinges (13, 16) the hinge axes of which are oriented transversely with respect to the longitudinal direction of the central beam (9).

7. Manipulator device according to claim 4, wherein the container engagement parts (5, 6) are rotatable with respect to the respective arms (19) according to a respective slewing axis (21) which is transverse with respect to the respective transverse hinge axis (13, 16) of said arms (19).

8. Manipulator device (3) according to claim 5, wherein the central beam (9) has an adjustable length.

9. Mobile container manipulator device (3), comprising ISO container engagement parts (5, 6), such as spreaders provided with twist lock devices (7), interconnected by a manipulator body (4), each of which container engagement parts (5, 6) is to be coupled to a respective ISO container (2), said manipulator body (4) providing a variable distance between said container engagement parts (5, 6), the respective connections between the manipulator body (4) and each container engagement part (5, 6) each having at least one pivot joint (13, 16, 21, 22) and having angle adjustment means (15, 18) providing a variable angular orientation of the container engagement part (5, 6) with respect to the manipulator body (4), wherein the manipulator body (4) and the drive means (12, 15, 18) are carried out for carrying the load of an ISO container (2) and possibly of the contents thereof while said ISO container (2) is suspended solely from one of the container engagement parts (5, 6) and the other container engagement part (5, 6) is held stationary.

10. Manipulator device (3) according to claim 9, wherein a power source (20) is provided, such as a combustion engine or electric battery, for powering the drive means, said power source being supported on the manipulator body (4) and/or at least one of the container engagement parts (5, 6).

11. Manipulator device (3) according to claim 9, wherein the manipulator body (4) comprises a central beam (9), such as a telescopic beam (10, 11), as well as arms (19) which are rotatably suspended at both ends of the central beam (9), e.g. through a transverse hinge axis (13, 16) oriented transverse with respect to the longitudinal direction of the central beam (9) and/or a longitudinal hinge axis (22) oriented according to the longitudinal direction of the central beam (9).

12. Manipulator device (3) according to claim 11, wherein the arms (19) are articulated (14, 17) according to at least two arm parts (14, 17).

13. Manipulator device (3) according to claim 12, wherein the arm parts (14, 17) of an arm (19) are rotatable, e.g. by means of piston/cylinder devices (15, 18), according to parallel hinges (13, 16) the hinge axes of which are oriented transversely with respect to the longitudinal direction of the central beam (9).

14. Manipulator device according to claim 11, wherein the container engagement parts (5, 6) are rotatable with respect to the respective arms (19) according to a respective slewing axis (21) which is transverse with respect to the respective transverse hinge axis (13, 16) of said arms (19).

15. Manipulator device (3) according to claim 12, wherein the central beam (9) has an adjustable length.

16. Method of handling containers loaded onboard a ship, which comprises:
providing a mobile container manipulator device (3) according to claim 1 having container engagement parts (5, 6) which are interconnected by a manipulator body (4) provided with drive apparatus (12, 15, 18) by means of which the distance and/or the angular orientation of said container engagement parts (5, 6) is influenced
providing containers (2) which are arranged according to adjacent stacks (1) of containers (2), wherein containers (2) of a stack are locked with respect to other containers in said stack,
making the container engagement parts (5, 6) of the mobile container manipulator device (3) engage different containers (2),
unlocking one of said containers (2) onto which the mobile container manipulator device (3) is engaged from a container in the same stack (1),
moving said unlocked container by energizing the drive apparatus (12, 15, 18) of the manipulator body (4) while changing the distance and/or angular orientation of said unlocked container (2) with respect to the other container onto which the container manipulation device (3) is engaged and while keeping stationary the other container (2) and the other container engagement part (6) engaged therewith.

17. The method according to claim 16, comprising the step of making the container engagement parts (5, 6) engage containers in different stacks (1).

18. The method according to claim 17, comprising the step of making the mobile container manipulator device (3) engage two upper containers (2) of different stacks (1).

19. The method according to claim 16, comprising the step of coupling the engagement parts (5, 6) with corner castings (8) of the containers (2).

20. The method according to claim 16, comprising the step of making the mobile container manipulator device (3) engage containers (2) which are positioned at different levels, such as a difference in level which is equal to the height of a single container or of multiple containers.

21. The method according to claim 16, comprising the steps of unlocking one of said containers (2) onto which the mobile container manipulator device (3) is engaged from a container in the same stack while maintaining the connection of the other container onto which the mobile container manipulator device is engaged to a container in the other stack.

22. Method of using a mobile container manipulator device (3) according to claim 1 having container engagement parts (5, 6) which are interconnected by a manipulator body (4) provided with drive apparatus (12, 15, 18) by means of which the distance and/or the angular orientation of said container engagement parts (5, 6) is influenced, the method comprising the steps of:
providing containers (2) which are arranged according to adjacent stacks (1) of containers (2),
making one of the container engagement parts (5, 6) of the mobile container manipulator device (3) engage a first container (2) and the other of the container engagement parts (5, 6) a second container (20),
releasing a container engagement part (5, 6) from the respective container (2) while maintaining the engagement between the other container engagement part (5, 6) and the respective container (2),
influencing the distance and/or the angular orientation of the released container engagement part (5, 6) with respect to the engaged container engagement part (5, 6),
engaging said released container engagement part (5, 6) with a third container (2) while maintaining the engagement between the other container engagement part (5, 6) and the respective container (2).
